(19) United States
(12) Patent Application Publication
(10) Pub. No.: US 2004/0197156 A1
(43) Pub. Date: Oct. 7, 2004

(54) Diamond hollow drill

(76) Inventor: Horst Karl Schraml, Grossraming (AT)

Correspondence Address: WILLIAM COLLARD, COLLARD & ROE, P.C., 1077 NORTHERN BOULEVARD, ROSLYN, NY, 11576, US

(21) Appl. No.: 10/485,053

(22) PCT Filed: Jul. 26, 2002
(86) PCT No.: PCT/AT02/00223

(30) Foreign Application Priority Data
Jul. 27, 2001 (AT) GM 594/2001

(51) Int. Cl. B23B 51/04

(52) U.S. Cl. 408/145

(57) ABSTRACT

In the case of a diamond hollow drill (1) whose hollow drill head (3) comprises a diamond coating the drill head (3) is arranged in the region of the diamond coating in a cutting crown (4) with outer, e.g. groove-like recesses and segments (5) at least between said recesses, with the segments outwardly projecting beyond the adjacent drill head part in its diameter. A counterboring ring (6) which can optionally be attachable to the drill head (3) comprises an insertion opening with recesses for the segments (5) of the cutting crown (1), which opening is substantially adjusted with respect to its shape to the outer contour of the cutting crown (4). The formation of burrs at the transition point between bore and counterbore is prevented through the cooperation of the segments (5) which determine the outside diameter of the bore and the counterboring regions projecting into a smaller dimensional region.

### FIELD OF THE INVENTION

The invention relates to a diamond hollow drill whose hollow cutting head comprises a diamond coating.

### DESCRIPTION OF THE PRIOR ART

Known diamond hollow drills which can be used for drilling flat and hollow glass as well as for drilling stone and ceramic material have the basic shape of a tube, with a diamond coating being attached to the cutting head end. It is common practice to especially drill glass from opposite sides because drilling on one side can lead to shell-like breakaways at the exit point of the drill. The drilling region is rinsed by water supplied under pressure through the drill opening during the drilling. It is often necessary to chamfer the drill holes on one or both sides, i.e. to bevel the edge between the cylindrical bore hole and the material surface on one or both sides. This is frequently performed by using a combined tool in which a so-called counterboring ring is attached to the diamond hollow drill whose working side has the desired conical form and can also be grooved or segmented for accelerating or improving the removal of material. This counterboring ring is pushed over the cutting head and is fixed with setting devices on the drill. A fixing or adjusting screw is mostly used on the fixing part of the counterboring ring. In order to allow the counterboring ring to be slid on, its opening diameter must not be more than the outside diameter of the diamond coating of the tubular drill. At least one hair gap is provided between the face side of the counterboring ring and the drill body. Due to the conical shape of the working side of the counterboring ring, a blade-like inclined edge is obtained which faces the workpiece and is obviously subject to the highest wear and tear. Both the hair gap as well as the wear and tear of said inclined edge whose inner diameter (as is explained above) always must be the same or larger than the outside diameter of the drill lead to the consequence that a burr is obtained at the transition point between the cylindrical drill hole and the beveled incline, which burr impairs the quality of the drill hole. As a result of this burr it is not possible to properly mount armatures whereby glass breakage cannot be excluded. Moreover, the thermal pre-tensioning of the glass is impaired by such a burr which can be the cause of breakage for the glass.

A hollow drill which is principally unsuitable for glass, is designated for drilling through glass-fiber reinforced plastic layered materials and is provided on the face side with a cutting crown made of diamond chips comprises slots in its jacket according to DE 34 46 296 A, which slots start out from the crown and change into a collar comprising an interior cone, with an adjusting cone being insertable into the interior cone with which the width of the said slots can be reduced by more or less tightening and thus the effective diameter of the drill crown can be changed or set. As was already mentioned, such a drill cannot be used for working glass. The attachment of a counterboring ring is neither possible nor would it make sense. Moreover, vibrations could occur in the cutting crown when drilling through glass as a result of the slots and could thus lead to an imprecise drilling process and, in the most extreme of cases, to glass breakage. In addition to setting the diameter it is necessary in this construction, as a result of the possible axial deviations of the clamped drill, to provide a compensating apparatus for the axial alignment with the drill spindle.

A countersinking, drilling and clamping tool is known from DE 26 01 519 A which is only intended for twist drills, in which at least one of the clamping jaws of the drill chucks is extended and engages in a spiral groove of the drill as a counterboring tool behind the blade, with a hard metal support being provided on said extension. The counterboring tool only takes effect when the clamping tool is moved towards the item to be drilled, so that in practice its use intended anyway only for metal working would only make sense when a continuous bore would be produced. The processing of glass with twist drills is not or hardly possible in practice. It is similarly impossible, as was already mentioned above, to drill from opposite sides and to attach the counterbore to a precisely defined extent. An increased likelihood of vibrations is given in this case too for the counterboring tool.

### SUMMARY OF THE INVENTION

It is the object of the present invention to provide a diamond hollow drill of the kind mentioned above which when used alone offers the same or better drilling performance than the known drills and when additionally used as a combination tool with a counterboring ring securely prevents over its entire service life the formation of burrs at the transition point between cylindrical drill hole and beveling.

This object is principally achieved in such a way that the drill head is provided in the region of the diamond coating of a cutting crown with external, e.g. groove-like recesses and with segments at least between said recesses, with said segments projecting outwardly beyond the diameter of the adjacent drill head portion and with a counterboring ring which can be attached to the drill head when required comprising an insertion opening with recesses for the segments of the drill crown, which insertion opening is adjusted with respect to its shape substantially to the external outline of the cutting crown.

A favorable discharge of the scouring liquid and the removed material is achieved through the groove-like recesses and the lateral flanks of the grooves and their end edges contribute favorably to the removal of material.

Any existing or formed gap between the drill head and the counterboring ring lies with its diameter always within (and not without as is the case in the known combination tools for glass and stone working) the drill hole produced by the cutting crown, or more precisely the outer edge of the segments, so that the formation of burrs can virtually be excluded. In other words, the motion paths of the segments of the cutting crown and the projections of the counterboring ring which is inserted by the grooves of the cutting crown will overlap in a mandatory fashion. It is irrelevant whether the counterboring ring, after being slid onto the drill head, remains in the inserted position when it is slid until behind the cutting crown or whether it is twisted relative to the cutting crown, which may prove to be appropriate in some cases in order to improve the scouring water guidance. The scouring water per se can then be supplied centrally or via the bores into the flanks of the bores. The counterboring ring maintains its symmetrical shape and therefore one that is balanced about the rotational axis. It is understood that it is also possible to provide an adapter for the hollow drill which allows a length adjustment for compensating the wear and tear of the drill. Such an adapter, rapid-action couplings for the same and devices for rapid length adjustment by using the adapter are the subject matter of PC/AT 02/00068 of 5 Mar. 2002 of the same applicant.

### BRIEF DESCRIPTION OF THE DRAWINGS

Further details and advantages of the subject matter of the invention are disclosed in the following description of the drawings:

The subject matter of the invention is now explained in closer detail by reference to the enclosed drawings, wherein:

FIG. 1 shows a diamond hollow drill in accordance with the invention with a counterboring ring in a partial longitudinal sectional view;

FIG. 2 shows the drill according to FIG. 1 in a bottom view, and

FIGS. 3 and 4 show a highly enlarged, schematic representation of a side of a drill hole shown in a sectional view when using a combination tool consisting of a diamond hollow drill and a counterboring ring in the known embodiment and in the subject matter of the invention.

### DESCRIPTION OF THE PREFERRED EMBODIMENTS

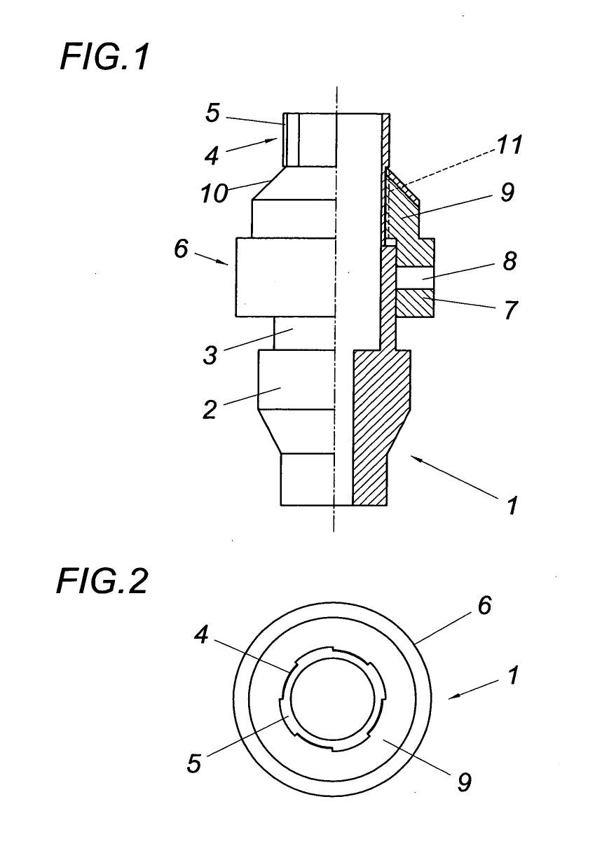

According to FIGS. 1 and 2, the diamond hollow drill 1 comprises a centring cone 2 in the known manner as a supporting body with an adjacent drill shank 3 and a cutting crown 4 whose outside diameter determines the drill hole diameter and which comprises outer groove-like recesses and, between the same, segments 5 which project outwardly over the adjacent drill head shank 3. In the embodiment the segments 5 and the groove-like recesses are shown with the same division. Both the division as well as the size relationship of segments 5 and the grooves can be changed and adapted according to the requirements or drill diameter.

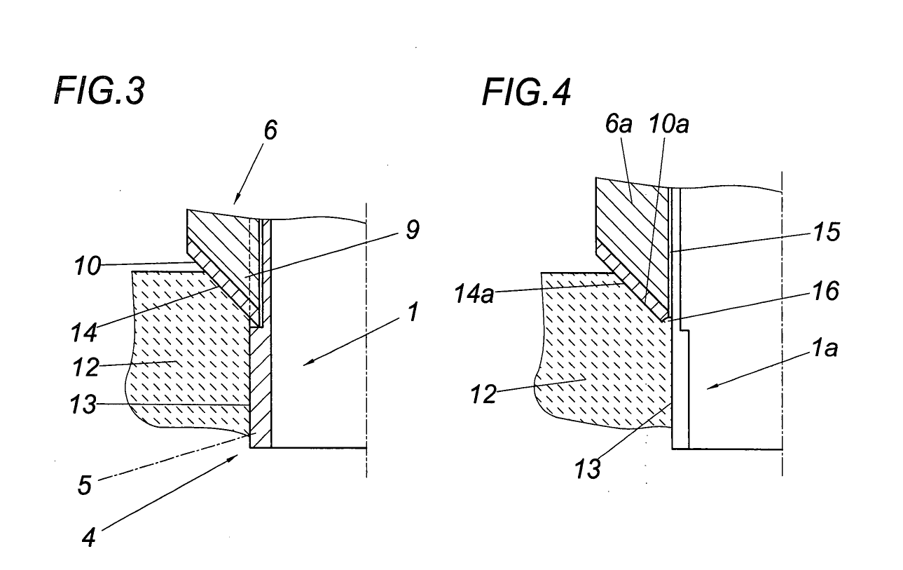

A counterboring ring 6 is slid over the cutting crown 4, which counterboring ring is formed from an annular fixing part 7 with insertion bore 8 for a fixing screw and the actual counterboring part 9 whose face side 10 has the conical inclination of the desired bevelling on the drill hole edge, but also comprises segmentations. These segmentations are obtained in the embodiment in such a way that the insertion opening of part 9 is adjusted to the external outline of the cutting crown 4, i.e. it comprises grooves or channels 11 which extend beyond segments 5. Segment projections remain between said grooves 11 which are illustrated as fitting into the grooves of the cutting crown, but may also have lateral play in said grooves. The counterboring ring 9 thus comprises regions between the grooves 11 whose inside diameter is smaller than the outside diameter of the segments 5, so that said regions, during the counterboring process, cannot come into engagement with the wall of the cylindrical drill hole as produced by the cutting crown and a gap, if any, between the counterboring ring opening and the outside of the drill extends with a distance within the outside diameter of the drill hole. This prevents any formation of burrs at the transition point between the cylindrical drill hole part and the counterboring, as will be explained in connection with FIGS. 3 and 4.

FIGS. 3 and 4 show a glass pane 12 each in which a drill hole 13 is provided with counterbores 14a or 14. When using a conventional tubular diamond hollow drill la-according to FIG. 4a, a counterboring ring 6a which may be segmented in its working surface will be situated with its excavation region 10a by forming a hair gap 15 adjacently to the body of the drill 1a. Moreover, the blade-like face parts of the body, which face parts are in engagement with material from the start of the counterboring process, are excavated rapidly, with the basic shape of the body being conical. Even along the hair gap 15 a part of the drill hole wall remains and is broken out in the form of fine splinters with increasing penetration of the counterboring ring. As a result of the wear and tear of the blade-like face parts, a burr 16 remains in addition to the hair gap region between the drill hole wall 13 and the counterbore 14a when the counterbore is completely produced, which burr—as was already mentioned—leads to difficulties in the insertion of armatures or other inserted parts and can lead to a starting point for glass breakage in case of pressure loads or occurring thermal tensions due to the imperfect glass working in this case.

In contrast to this, the drill hole 13 is produced in its diameter by the outside of the segments 5 of the cutting crown 4 when a combination tool 1 in accordance with FIG. 3 and the invention is used and at least the segments 9 of the counterboring ring 6 rest with their inside within the produced drill hole 13, so that these segments produce the counterbore 14 not with their inner blade-like end but already with a flank and thus no burr 16 can be produced as in FIG. 3.

1. A diamond hollow drill whose hollow cutting head comprises a diamond coating, characterized in that the drill head (3) is arranged in the region of the diamond coating in a cutting crown (4) with outer, e.g. groove-like recesses and segments (5) at least between said recesses, with the segments outwardly projecting beyond the adjacent drill head part in its diameter and with a counterboring ring (6) which can optionally be attachable to the drill head comprising an insertion opening with recesses for the segments (5) of the cutting crown (4), which opening is substantially adjusted with respect to its shape to the outer contour of the cutting crown (4).
